(19) United States
(12) Patent Application Publication
(10) Pub. No.: US 2008/0151701 A1
(43) Pub. Date: Jun. 26, 2008

(54) METHOD AND APPARATUS FOR IDENTIFYING OPTICAL INFORMATION STORAGE MEDIUM

(75) Inventors: Young-jae PARK, Yongin-si (KR); Kab-kyun Jeong, Yongin-si (KR); Sung-hyun Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/749,377

(22) Filed: May 16, 2007

(30) Foreign Application Priority Data
Dec. 22, 2006 (KR) 2006-133087

(51) Int. Cl. G11B 11/00

(52) U.S. Cl. 369/13.53

(57) ABSTRACT

A method and apparatus for identifying an optical information storage medium, the method of identifying the optical information storage medium loaded into an apparatus for reproducing/recording the optical information storage medium including: moving an object lens at a predetermined velocity in a first direction or a second direction while the optical information storage medium is loaded; generating a sum signal by adding magnitudes of beams reflected by the optical information storage medium and condensed by an optical detector; measuring a first time period during which the sum signal has a value greater than a first level; and detecting a thickness of data layers of the optical information storage medium based on the first time period, wherein the thickness of the data layers corresponds to the type of the optical information storage medium.

### CROSS-REFERENCE TO RELATED APPLICATIONS

This application claims all benefits accruing under 35 U.S.C. §119 from Korean Patent Application No. 2006-133087, filed on Dec. 22, 2006 in the Korean Intellectual Property Office, the disclosure of which is incorporated herein by reference.

### BACKGROUND OF THE INVENTION

1. Field of the Invention

Aspects of the present invention relate to a method of identifying a multi-layer optical information storage medium, and more particularly, to a method of identifying the number of data layers included in an optical information storage medium by detecting the total thickness of the data layers.

2. Description of the Related Art

Optical discs are widely used as optical information storage media capable of recording a large amount of data. New high-density optical recording media, such as Blu-ray discs and high definition digital versatile discs (HD DVDs), can record and store even more high-definition video data and high-quality audio data than the conventional optical discs.

Blu-ray discs utilize next-generation HD-DVD technology to offer a data storage capacity far exceeding that of conventional DVDs. Specifically, a Blu-ray disc can store 25 gigabytes (GB) of data on each side. Currently, a dual-layer disc that can store 50 GB of information on two layers is being released onto the market, and a high-density multi-layer disc that can store more than 100 GB of information is being developed.

FIG. 1 illustrates the structure of a dual-layer disc. This disc is a high-density, dual-layer Blu-ray disc having a high numerical aperture of 0.85 and a wavelength of 405 nm. Referring to FIG. 1, a surface layer, a cover layer, a data layer L1, a spacer layer, and a data layer L0 are sequentially stacked on a substrate, in that order, from the bottom of the disc (i.e., the surface to which an optical beam is incident) to the top. The total thickness of the dual-layer disc is 1.2 mm, whereby the thicknesses of the cover layer, the spacer layer, and the substrate are 75 μm, 25 μm, and 1.1 mm, respectively. A variety of information regarding the optical disc is recorded on the data layers L1 and L0.

FIG. 2 illustrates the structure of a multi-layer disc. The disc is a multi-layer Blu-ray disc that includes more layers than a dual-layer disc in order to provide a greater storage capacity. As described above, a Blu-ray disc can store 25 GB of information on each surface. Compared with the dual-layer disc illustrated in FIG. 1, the multi-layer disc includes a plurality of data layers L0 through Ln−1 and, thus, a plurality of spacer layers delta_1 through delta_n.

Like the dual-layer disc illustrated in FIG. 1, the multi-layer disc illustrated in FIG. 2 includes a surface layer, a cover layer, a data layer Ln−1, a spacer layer, a data layer Ln−2, a spacer layer, and a data layer L0 sequentially stacked on a substrate, in that order, from the bottom of the disc (i.e., the surface to which an optical beam is incident) to the top. A method of optimizing reflectivity of each data layer and the intervals between the data layers in order to minimize inter-layer interference is being studied. In general, the optimal thickness of a spacer layer for minimizing interference in a multi-layer structure is between 10 μm and 25 μm.

In addition, the lowest data layer (i.e., the data layer Ln−1) of the multi-layer disc illustrated in FIG. 2 is lower than the lowest data layer (i.e., the data layer L1) of the dual-layer disc illustrated in FIG. 1. Similarly, the highest data layer (i.e., the data layer L0) of the multi-layer disc illustrated in FIG. 2 is higher than the highest data layer (i.e., the data layer L0) of the dual-layer disc illustrated in FIG. 1.

In order to accommodate various types of optical discs having different physical characteristics according to their thickness, the compatibility of the optical discs should be increased. This can be achieved through a detect disc type (DDT) process. Identifying an optical disc can include determining whether an optical disc is a low-density disc or a high-density disc, whether the optical disc is a read-only disc or a recordable disc, and whether the optical disc has a single layer or a plurality of layers. The DDT process is performed while an optical disc is loaded into an apparatus for reproducing/recording data on/from the optical disc.

Identifying the number of layers of an optical disc requires an automatic adjustment process in which a radio frequency (RF) amplifier loads a default value for each layer of an optical disc in response to a servo error signal and optimizes the default values for the optical disc. Therefore, identifying the number of data layers on an optical disc is very important. In addition, reducing the time required for identifying an optical disc in order to reduce the lead-in time of the disc is also important.

FIG. 3 illustrates a conventional method of identifying an optical disc. Referring to FIG. 3, while an optical disc is loaded into a reproducing/recording apparatus, an object lens (not shown) is moved perpendicular to the optical disc. Then, a signal is measured based on the amount of light reflected by the optical disc and condensed by a quadrant optical detector (not shown) as illustrated in FIGS. 4A and 4B. In so doing, the type of optical disc is identified. The quadrant optical detector is an optical detector divided into quadrants labeled A through D in a counter-clockwise direction to generate a focus error signal (FES) and a radio frequency direct current (RFDC) signal based on information regarding the amount of light that is incident on each of the regions A through D.

The object lens is moved in response to a focus drive (FOD) signal, and the position at which an optical beam is focused is determined according to the movement of the object lens. If the object lens moves upward, the focal position of the optical beam is raised. If the object lens moves downward, the focal position of the optical beam is lowered.

An RF amplifier (not shown) performs an operation ([(A+C)−(B+D)]) on beams received from the quadrant optical detector, using an astigmatic method, and outputs the FES. The RF amplifier adds the beams (A+B+C+D) received from the quadrant optical detector and outputs the RFDC signal which corresponds to the sum.

FIG. 4A illustrates the form of an optical beam collected by a quadrant optical detector when the optical beam is focused precisely on a data layer. FIG. 4B illustrates the form of an optical beam collected by a quadrant optical detector when the optical beam is not focused precisely on a data layer.

Referring to FIG. 4A, if a beam is focused precisely on the data layers L1 and L0, the beam condensed by the quadrant optical detector is uniform in each of the regions A through D. In this case, due to the astigmatic method, the FES has a value of zero, and the RFDC signal has a maximum value. Therefore, as illustrated in FIG. 3, if the optical beam is focused precisely on the data layers L1 and L0, the FES has a value of zero and the RFDC signal has a maximum value.

Referring to FIG. 4B, if a beam is not focused precisely on the data layers L1 and L0, the beam condensed by the quadrant optical detector is not uniform in each of the regions A through D. Therefore, as illustrated in FIG. 3, as the optical beam is focused closer than the data layers L1 and L0, the FES is positive. Conversely, as the optical beam is focused farther than the data layers L1 and L0, the FES is negative. That is, the FES has an S-curved shape based on the data layers L1 and L0, and the RFDC signal has a parabolic shape based on the data layers L1 and L0. In the case of a surface layer, since the reflectivity of the surface layer is low, both the FES and the RFDC signal have a narrow range of fluctuation.

As illustrated in FIG. 3, if the value of the FES drops from positive to negative following the upward or downward movement of the object lens, an FES layer count signal alternately shows positive and negative pulses. Conversely, if the value of the FES rises from negative to positive, the FES layer count signal alternately shows negative and positive pulses. The number of data layers on an optical disc can be identified by counting the number of times that the FES layer count signal changes from positive to negative or from negative to positive.

When the object lens is moved upward or downward, if the RFDC signal is higher than a first slice level, the RFDC layer count signal becomes a high level. Therefore, a data layer can be identified by detecting when the RFDC layer count signal becomes a high level. That is, when the object lens is moved upward, if a section in which the value of the RFDC signal is greater than a second slice level is detected, the section is determined to be a surface layer. After the surface layer is detected, the object lens is continuously moved upward. Then, if a section in which the value of the RFDC signal is greater than the first slice level is detected, that section is determined to be a data layer. After the data layer is identified in this way, the object lens is moved downward. As illustrated in FIG. 3, the first slice level is used to identify the data layer, and the second slice level, which is lower than the first slice level, is used to identify the surface layer.

The thicknesses of a cover layer and a spacer layer may vary according to the specification of the optical disc. Therefore, spherical aberration, which is a distortion of a signal due to a difference in thickness, may occur. As a result, the apparatus for reproducing/recording an optical information storage medium additionally corrects spherical aberration. In order to correct spherical aberration and compensate for the difference in thicknesses of layers of different optical discs, an optical beam is focused on one of a plurality of data layers. Then, the optical beam is focused on the remaining data layers based on the first data layer.

However, in the conventional method of identifying the number of data layers of an optical disc using the FES and the RFDC signal, the layer count signal may be indistinct according to the position of spherical aberration correction. Therefore, it may be impossible to accurately identify the number of data layers.

FIG. 5 illustrates an example of an error in counting the number of data layers using the conventional method. Referring to FIG. 5, if spherical aberration is corrected based on a data layer L0, the reflectivity of an optical beam by a data layer L1 is reduced. As a result, the sizes of the FES and the RFDC signal are also reduced. Therefore, the FES layer count signal and the RFDC layer count signal all become low levels for the data layer L1, thereby failing to properly count the data layer L1.

FIG. 6 illustrates another example of an error in counting the number of data layers using the conventional method. Referring to FIG. 6, a distorted signal may be counted between a surface layer and a data layer L1 according to positive and negative levels set for the FES. As described above, according to the conventional method of identifying the number of data layers of a multi-layer disc, even if the spherical aberration is set in the data layer L1, the data layer L0, or between the data layers L1 and L0, it is difficult to know whether the spherical aberration has been moved to an optimal position when an optical beam is not yet focused. In addition, the position of the spherical aberration may vary according to the system used by an apparatus for reproducing/recording an optical information storage medium. Further, due to signal distortion and improper balance between positive and negative values of the FES, it is difficult to accurately identify the number of data layers.

In particular, according to the conventional method, as the number of data layers of an optical disc increases, identification of the number of data layers becomes less accurate due to signal degradation caused by inter-layer interference.

### SUMMARY OF THE INVENTION

Aspects of the present invention provide a method of identifying the thickness and number of data layers of a multi-layer optical disc loaded into an apparatus for reproducing/recording an optical disc.

Additional aspects and/or advantages of the invention will be set forth in part in the description which follows and, in part, will be obvious from the description, or may be learned by practice of the invention.

According to an aspect of the present invention, there is provided a method of identifying a type of an optical information storage medium loaded into an apparatus for reproducing/recording the optical information storage medium. The method includes moving an object lens at a predetermined velocity in a first direction or a second direction while the optical information storage medium is loaded into the apparatus; generating a sum signal by adding magnitudes of beams reflected by the optical information storage medium and condensed by an optical detector; measuring a first time period during which the sum signal has a value greater than a first level; and detecting a thickness of data layers of the optical information storage medium based on the first time period, wherein the thickness of the data layers corresponds to the type of the optical information storage medium.

The method may further include identifying a number of the data layers of the optical information storage medium based on the first time period.

The identifying of the number of the data layers may include: identifying the optical information storage medium as a single-layer optical information storage medium if the first time period is greater than a first reference value and less than a second reference value; identifying the optical information storage medium as a dual-layer optical information storage medium if the first time period is greater than a third reference value, which is greater than the second reference value, and less than a fourth reference value; and identifying the optical information storage medium as a multi-layer optical information storage medium if the first time period is greater than a fifth reference value, which is greater than the fourth reference value, and less than a sixth reference value.

If the first time period is less than the first reference value, a surface layer of the optical information storage medium may be identified as corresponding to the sum signal having the value greater than the first level.

The method may further include correcting a spherical aberration of the optical information storage medium according to the identified number of the data layers of the optical information storage medium.

The optical information storage medium may have a wavelength of more than 405 nm and an aperture of more than 0.85.

According to another aspect of the present invention, there is provided an apparatus for identifying a type of a loaded optical information storage medium. The apparatus includes an optical pickup unit to condense beams reflected by the optical information storage medium onto an optical detector by moving an object lens at a predetermined velocity in a first direction or a second direction; a radio frequency (RF) amplification unit to generate a sum signal by adding magnitudes of the condensed beams; and a servo signal processing unit to measure a first time period during which the sum signal has a value greater than a first level and to detect a thickness of data layers of the optical information storage medium based on the first time period, wherein the thickness of the data layers corresponds to the type of the optical information storage medium.

According to another aspect of the present invention, there is provided a method of identifying a type of an optical information storage medium loaded into an apparatus for reproducing/recording the optical information storage medium and generating a radio frequency direct current (RFDC) signal corresponding to magnitudes of beams reflected by the optical information storage medium. The method includes: measuring a first time period during which the RFDC signal has a value greater than a first level; and determining a number of data layers of the optical information storage medium based on the first time period, wherein the number of the data layers corresponds to the type of the optical information storage medium.

According to another aspect of the present invention, there is provided an apparatus for identifying a type of an optical information storage medium loaded into a device for reproducing/recording the optical information storage medium and generating a radio frequency direct current (RFDC) signal corresponding to magnitudes of beams reflected by the optical information storage medium. The apparatus includes: a detect disc type (DDT) control unit to measure a first time period during which the RFDC signal has a value greater than a first level and to detect a number of data layers of the optical information storage medium based on the first time period, wherein the number of the data layers corresponds to the type of the optical information storage medium.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates the structure of a dual-layer disc;

FIG. 2 illustrates the structure of a multi-layer disc;

FIG. 3 illustrates a conventional method of identifying an optical disc;

FIG. 4A illustrates the form of an optical beam collected by a quadrant optical detector when the optical beam is focused precisely on a data layer;

FIG. 4B illustrates the form of an optical beam collected by a quadrant optical detector when the optical beam is not focused precisely on a data layer;

FIG. 5 illustrates an example of an error in counting the number of data layers using the conventional method;

FIG. 6 illustrates another example of an error in counting the number of data layers using the conventional method;

FIG. 7 is a block diagram of an apparatus for recording/reproducing an optical disc according to an example embodiment of the present invention;

FIG. 8 is a diagram of an optical pickup unit according to an example embodiment of the present invention;

FIG. 9 is a diagram of a servo signal processing unit according to an example embodiment of the present invention;

FIG. 10 illustrates a focus error signal (FES) and a radio frequency direct current (RFDC) signal according to an example embodiment of the present invention; and

FIG. 11 is a flowchart illustrating a method of determining a type of optical disc using a detect disc type (DDT) control unit according to an example embodiment of the present invention.

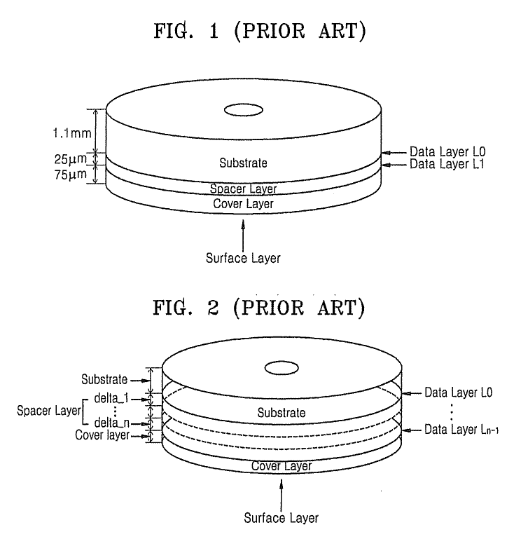

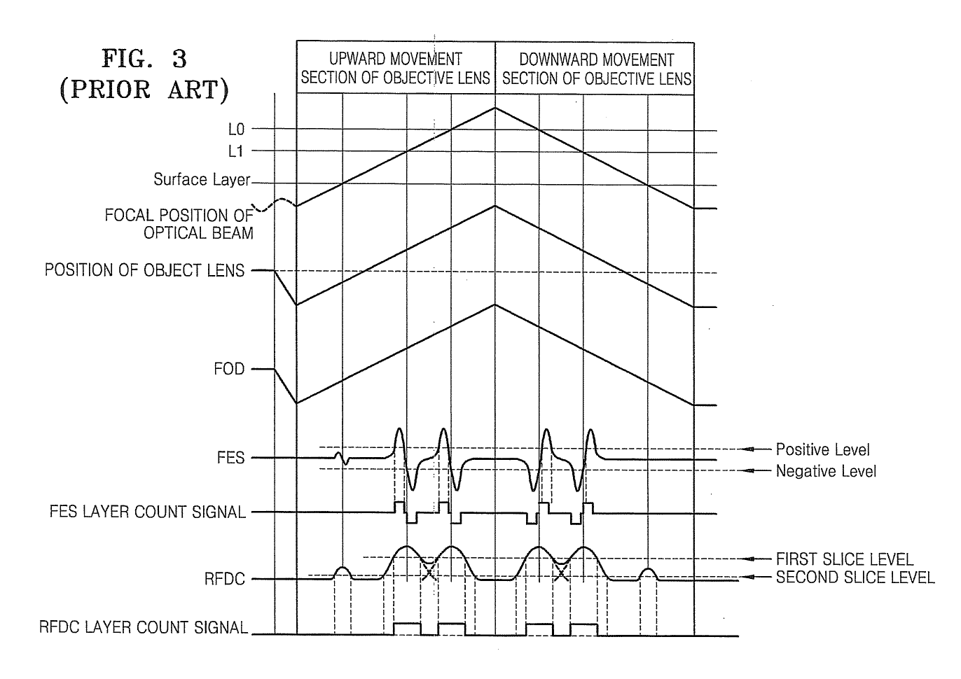

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

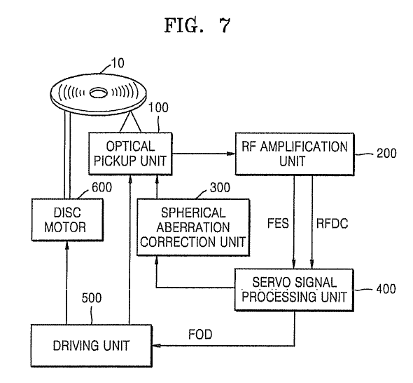

FIG. 7 is a block diagram of an apparatus for recording/reproducing data on/from an optical disc 10 according to an example embodiment of the present invention. Referring to FIG. 7, the apparatus includes an optical pickup unit 100, a radio frequency (RF) amplification unit 200, a spherical aberration correction unit 300, a servo signal processing unit 400, a driving unit 500, and a disc motor 600.

The optical pickup unit 100 is driven by a tracking actuator to control a tracking servo and a focusing actuator to control a focus servo. The optical pickup unit 100 converts an optical beam that is received from an optical disc 10 into a digital or electrical RF signal. That is, the optical pickup unit 100 picks up information recorded on an optical disc 10, converts the information into a digital or electrical RF signal, and outputs the digital or electrical RF signal to the RF amplification unit 200.

The RF amplification unit 200 amplifies the RF signal output from the optical pickup unit 100. Here, the RF amplification unit 200 performs an operation ([(A+C)−(B+D)]) on beams received from a quadrant optical detector (which is included in the optical pickup unit 100) using an astigmatic method and outputs a focus error signal (FES). In addition, the RF amplification unit 200 adds the beams (A+B+C+D) received from the quadrant optical detector and outputs a radio frequency direct current (RFDC) signal which corresponds to the sum.

The spherical aberration correction unit 300 focuses an optical beam on a selected one of a plurality of data layers and then focuses the optical beam on the other data layers based on the selected data layer in order to compensate for differences in the thicknesses of layers of different optical discs.

The servo signal processing unit 400 receives the FES and the RFDC signal from the RF amplification unit 200 and outputs a focus drive (FOD) signal to the spherical aberration correction unit 300 and the driving unit 500 in order to move an object lens in a first direction or a second direction (such as upward or downward), perpendicular to the optical disc 10, to adjust the focal position of an optical beam.

The driving unit 500 includes the focusing actuator and a focus drive (not shown). The driving unit 500 drives the focusing actuator in response to the FOD signal output from the servo signal processing unit 400, and moves the object lens up or down, perpendicular to the optical disc 10.

The disc motor 600 rotates the optical disc 10 at a constant linear velocity (CLV) or a constant angular velocity (CAV) in response to a disc driving signal output from the driving unit 500.

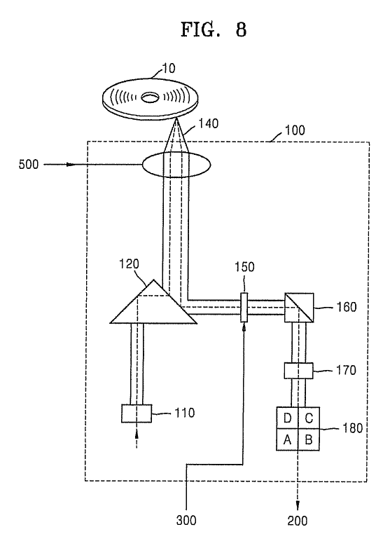

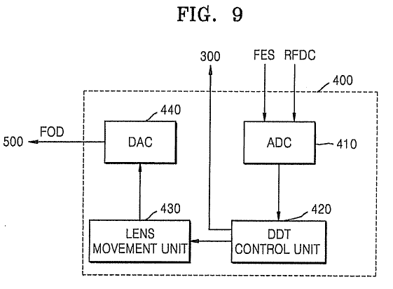

FIG. 8 is a diagram of the optical pickup unit 100 according to an example embodiment of the present invention. Referring to FIG. 8, the optical pickup unit 100 includes a laser diode (LD) 110, a reflecting mirror 120, an object lens 130, an optical beam 140, a collimator lens 150, a beam splitter 160, a condensing lens 170, and a quadrant optical detector 180.

When the LD 110 is on, light emitted from the LD 110 is reflected by the reflecting mirror 120 onto the object lens 130. Then, light output from the object lens 130 is condensed onto an optical disc through the optical beam 140, and light reflected by the object lens 130 is split by the beam splitter 160 via the collimator lens 150. Here, the spherical aberration correction unit 300 transmits a signal to the collimator lens 150 in order to correct spherical aberration which occurs according to the thickness of the optical disc 10. Then, the collimator lens 150 adjusts the focal position of the light on the optical disc 10 while moving to a first direction and a second direction (for example, right and left).

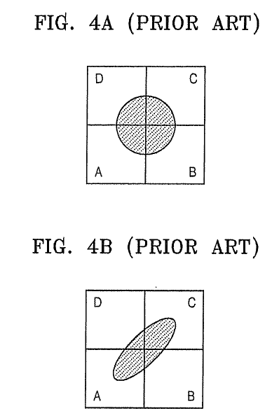

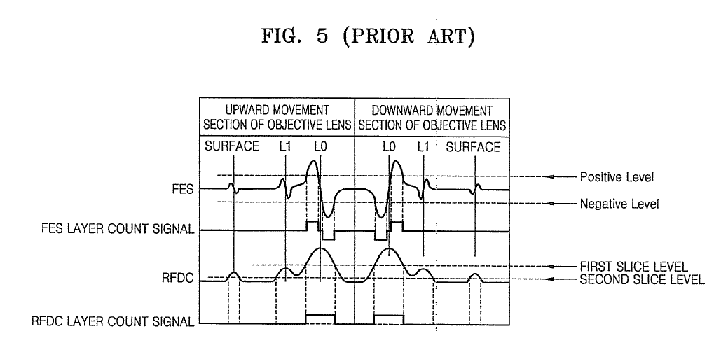

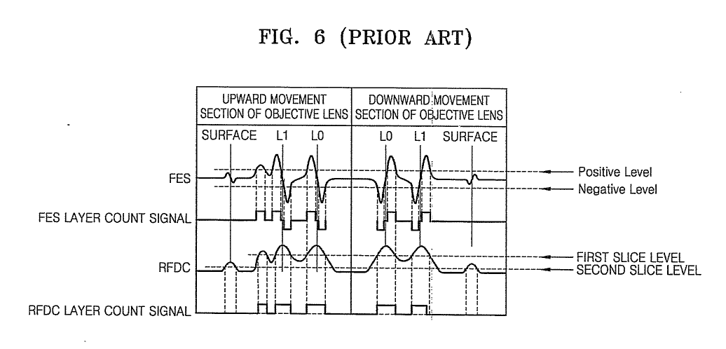

The light split by the beam splitter 160 is condensed by the condensing lens 170 and then transmitted to the quadrant optical detector 180. The quadrant optical detector 180 transmits the amount of light incident on each of A through D regions (such as illustrated in FIGS. 4A and 4B) to the RF amplification unit 200.

As described above, the RF amplification unit 200 performs an operation on the light received from the quadrant optical detector using the astigmatic method, and generates the FES. In addition, the RF amplification unit 200 adds the light (A+B+C+D) received from the quadrant optical detector and outputs the RFDC signal. Then, the RF amplification unit 200 outputs the FES and RFDC signal to the servo signal processing unit 400.

FIG. 9 is a diagram of the servo signal processing unit 400 according to an example embodiment of the present invention. Referring to FIG. 9, the servo signal processing unit 400 includes an analog-digital converter (ADC) 410, a detect disc type (DDT) control unit 420, a lens movement unit 430, and a digital-analog converter (DAC) 440.

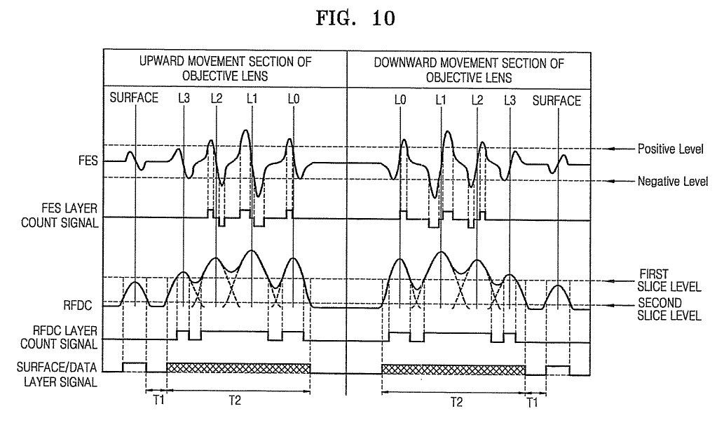

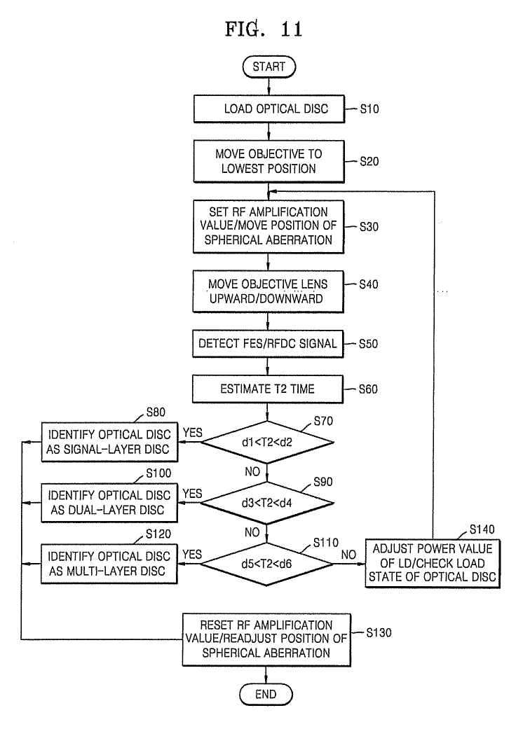

The ADC 410 converts the FES and the RFDC signal output from the RF amplification unit 200 into digital signals and outputs the digital signals to the DDT control unit 420. The DDT control unit 420 transmits a signal to the lens movement unit 430 to control the lens movement unit 430 to move the object lens 130 upward or downward, perpendicular to the optical disc 10, thereby obtaining the FES and the RFDC signal. The DDT control unit 420 also determines the type of the optical disc 10 currently loaded into the system based on the FES and the RFDC signal. A method used by the DDT control unit 420 to determine the type of the optical disc 10 currently loaded into the system, based on the FES and the RFDC signal, will be described in detail later with reference to FIGS. 10 and 11. In addition, the DDT control unit 420 transmits the FES and the RFDC signal to the spherical aberration correction unit 300 to control the spherical aberration correction unit 300 to correct a spherical aberration in the system.

The lens movement unit 430 outputs the FOD signal to the driving unit 500 via the DAC 440 to move the object lens 130 upward or downward, perpendicular to the optical disc 10, thereby adjusting the focal position of the optical beam. If the lens movement unit 430 adds a predetermined value to a current FOD value and outputs the sum to the driving unit 500, the driving unit 500 moves the objective lens 130 upward, closer to the optical disc 10. Conversely, if the lens movement unit 430 subtracts the predetermined value from the current FOD value and outputs the difference to the driving unit 500, the driving unit 500 moves the objective lens 130 downward, farther away from the optical disc 10.

If the object lens 130 is moved upward or downward in this way, the RF amplification unit 200 generates the FES and the RFDC signal as illustrated in FIG. 10. Then, the DDT control unit 420 determines the type of the optical disc 10 currently loaded into the system based on the FES and RFDC signal.

FIG. 10 illustrates an FES and an RFDC signal according to an example embodiment of the present invention. FIG. 11 is a flowchart illustrating a method of determining a type of optical disc 10 using the DDT control unit 420 according to an example embodiment of the present invention.

When an optical disc 10 is loaded (operation S10), the DDT control unit 420 sends a signal to the lens movement unit 430 to determine the type of the optical disc 10. Then, the lens movement unit 430 moves the object lens 130 to its lowest position in order to detect a surface layer (operation S20). The RF amplification unit 200 sets an RF amplification value corresponding to the position of the object lens 130, and the spherical aberration correction unit 300 moves a position of the spherical aberration correction, thereby adjusting the focal position of the optical beam (operation S30). In FIG. 10, it is assumed that the position of spherical aberration correction is a data layer L1.

The object lens 130 is moved at a predetermined velocity in a first direction and a second direction (such as upward and downward perpendicular to the optical disc 10) (operation S40). That is, the object lens 130 is raised to a position where the focal position of the optical beam can detect a data layer and then lowered to a position where the focal position of the optical beam can detect the surface layer of the optical disc 10. The predetermined velocity may be a constant velocity.

While moving the object lens 130 upward and downward, the FES and the RFDC signal are detected based on the amount of light reflected by the optical disc 10 and condensed by the quadrant optical detector 180 (operation S50) and output as illustrated in FIG. 10. FIG. 10 shows the FES and the RFDC signal generated by moving the objective lens 130 perpendicular to the optical disc 10 having four data layers L3 through L0.

According the present example embodiment, as illustrated in FIG. 10, if the RFDC signal has a value higher than a second slice level when the object lens 130 is moved upward or downward, a surface/data layer signal becomes a first level (such as a high level). T1 indicates the time taken for the focus of the optical beam to pass through a cover layer between the surface layer and the data layer L3. T2 indicates the time taken for the focus of the optical beam to pass from the lowest data layer L3 to the highest data layer L0.

Therefore, the DDT control unit 420 measures the time T2 taken for the focus of the optical beam to pass from the lowest data layer L3 to the highest data layer L0 based on the FES and the RFDC signal of FIG. 10 (operation S60). Then, the DDT control unit 420 detects the thickness of the optical disc 10 based on the time T2. That is, the thickness of the entire optical disc 10 can be obtained based on the time T2.

First, the DDT control unit 420 determines, in a standard time comparison, whether the time T2 is greater than d1 and less than d2 (operation S70). It is understood that d1, d2, d3, d4, d5, and d6 are predetermined reference times determined by, for example, experimentation and corresponding to time ranges for an optical beam to pass through a specific number of data layers of an optical disc 10. For example, d1 and d2 correspond to a range of time needed for an optical beam to pass through a single data layer. If the DDT control unit 420 determines that the time T2 is greater than d1 and less than d2, the DDT control unit 420 determines that the optical disc 10 is a single-layer disc (operation S80).

If the time T2 is not in the range of d1 to d2, the DDT control unit 420 determines whether the time T2 is greater than d3 and less than d4 (operation S90). If the DDT control unit 420 determines that the time T2 is greater than d3 and less than d4, the DDT control unit 420 determines that the optical disc 10 is a dual-layer disc (operation S100). Here, d3 is greater than d2.

Similarly, if the time T2 is not in the range of d3 to d4, the DDT control unit 420 determines whether the time T2 is greater than d5 and less than d6 (operation S110). If the DDT control unit 420 determines that the time T2 is greater than d5 and less than d6, the DDT control unit 420 determines that the optical disc 10 is a multi-layer disc (operation S120). Here, d5 is greater than d4.

If a conventional method was applied to the example embodiment illustrated in FIG. 10, the data layers L2 and L1 would be incorrectly identified as a single data layer because the RFDC signal remains higher than a first slice level and the layer count signal remains in a high level when the optical beam to passes through the data layers L2 and L1. Therefore, the number of data layers cannot be accurately identified using the conventional method.

If the DDT control unit 420 identifies the number of layers based on the thickness of the uploaded optical disc 10, the DDT control unit 420 moves the position of spherical aberration according to the identified number of layers of the optical disc 10. In addition, the RF amplification unit 200 resets an RF amplification value (operation S130).

Furthermore, if the time T2 is not in the range of d1 to d2, d3 to d4, or d5 to d6, the power of the LD 110 is adjusted, or the loading state of the optical disc 10 is checked (operation S140). In doing so, the RF amplification and the position of spherical aberration are adjusted again. In addition, when the focus of the optical beam passes through the surface layer, the period of time during which the surface/data layer signal maintains a high level may be significantly reduced. Therefore, if the time T2 is less than d1, the surface layer is not counted as a data layer.

As described above, according to aspects of the present invention, while moving the object lens 130 in a first direction and a second direction (for example, upward or downward), the time taken for the focus of the optical beam to pass from the lowest data layer to the highest data layer is measured. Therefore, the thickness of the data layers of the optical disc 10 can be obtained, and the type of the optical disc 10 can be determined based on the thicknesses. In particular, since signal degradation caused by interference that occurs in a high-density disc does not affect the measurement of the time taken for the focus of the optical beam to pass from the lowest data layer to the highest data layer, the type of the optical disc 10 can be more accurately determined.

Furthermore, according to aspects of the present invention, in the case of an optical disc 10 having a wavelength of more than 405 nm and an aperture of more than 0.85, data layers can be more accurately identified.

Alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Furthermore, the software modules as described can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

As described above, in a method of identifying an optical information storage medium loaded into an apparatus for reproducing/recording an optical information storage medium, the duration of an RFDC signal (which is generated when an objective is moved upward or downward with respect to a multi-layer optical disc 10) is measured, allowing the number and thickness of data layers to be accurately identified. Therefore, compatibility can be enhanced according to the type of the optical information storage medium.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, functional units of the apparatus for identifying optical information storage medium may be combined and integrated into a single control unit (such as the DDT control unit 420 and the lens movement unit 430 illustrated in FIG. 9). Furthermore, the operations to detect the thickness of the data layers can include more or less reference time comparisons (such as determining if T2 as shown in the method illustrated in FIG. 11 is between a d7 and a d8) to more precisely, more quickly, and/or more expansively determine the thickness. Moreover, aspects of the present invention can just supplement the prior art. For example, an apparatus that just measures the T2 time period from an RFDC signal can be implemented in a recording/reproducing apparatus of the prior art. Accordingly, it is intended, therefore, that the present invention not be limited to the various example embodiments disclosed, but that the present invention includes all embodiments falling within the scope of the appended claims.

What is claimed is:

1. A method of identifying a type of an optical information storage medium loaded into an apparatus for reproducing/recording data on/from the optical information storage medium, the method comprising:
moving an object lens at a predetermined velocity in a first direction or a second direction while the optical information storage medium is loaded into the apparatus;
generating a sum signal by adding magnitudes of beams reflected by the optical information storage medium;
measuring a first time period during which the sum signal has a value greater than a first level; and
detecting a thickness of data layers of the optical information storage medium based on the first time period so as to identify the type of the optical information storage medium.

2. The method as claimed in claim 1, wherein the detecting of the thickness comprises:
identifying a number of the data layers of the optical information storage medium based on the first time period.

3. The method as claimed in claim 2, wherein the identifying of the number of the data layers of the optical information storage medium comprises:
identifying the optical information storage medium as a single-layer optical information storage medium if the first time period is greater than a first reference value and less than a second reference value;
identifying the optical information storage medium as a dual-layer optical information storage medium if the first time period is greater than a third reference value, which is greater than the second reference value, and less than a fourth reference value; and
identifying the optical information storage medium as a multi-layer optical information storage medium if the first time period is greater than a fifth reference value, which is greater than the fourth reference value, and less than a sixth reference value.

4. The method as claimed in claim 3, wherein if the first time period is less than the first reference value, a surface layer of the optical information storage medium is identified as corresponding to the sum signal having the value greater than the first level.

5. The method as claimed in claim 2, further comprising:
correcting a spherical aberration of the optical information storage medium according to the identified number of the data layers of the optical information storage medium.

6. The method as claimed in claim 1, wherein the first direction is an upward direction towards the optical information storage medium and the second direction is a downward direction away from the optical information storage medium.

7. The method as claimed in claim 1, further comprising:
moving the object lens to a lowest position of the optical information storage medium to detect a surface layer of the optical information storage medium before the moving of the object lens in the first direction or the second direction.

8. The method as claimed in claim 1, wherein the predetermined velocity is a constant velocity.

9. The method as claimed in claim 3, further comprising:
adjusting a power value of a laser diode emitting the beams if the first time period is greater than the sixth reference value.

10. The method as claimed in claim 3, further comprising:
checking a load state of the optical information storage medium if the first time period is greater than the sixth reference value.

11. The method as claimed in claim 2, wherein the identifying of the number of the data layers of the optical information storage medium comprises:
identifying the optical information storage medium as a single-layer optical information storage medium if the first time period is greater than a first reference value and less than a second reference value; and
identifying the optical information storage medium as a multi-layer optical information storage medium if the first time period is greater than a third reference value, which is greater than the second reference value, and less than a fourth reference value.

12. An apparatus for identifying a type of an optical information storage medium, the apparatus comprising:
an optical pickup unit to condense beams reflected from the optical information storage medium by moving an object lens at a predetermined velocity in a first direction or a second direction;
a radio frequency (RF) amplification unit to generate a sum signal by adding magnitudes of the condensed beams; and
a servo signal processing unit to measure a first time period during which the sum signal has a value greater than a first level and to detect a thickness of data layers of the optical information storage medium based on the first time period, so as to identify the type of the optical information storage medium.

13. The apparatus as claimed in claim 12, wherein the servo signal processing unit identifies a number of the data layers of the optical information storage medium based on the first time period.

14. The apparatus as claimed in claim 13, wherein the servo signal processing unit comprises a detect disc type (DDT) control unit to identify the optical information storage medium as:
a single-layer optical information storage medium if the first time period is greater than a first reference value and less than a second reference value;
a dual-layer optical information storage medium if the first time period is greater than a third reference value, which is greater than the second reference value, and less than a fourth reference value; and
a multi-layer optical information storage medium if the first time period is greater than a fifth reference value, which is greater than the fourth reference value, and less than a sixth reference value.

15. The apparatus as claimed in claim 13, wherein the servo signal processing unit comprises a detect disc type (DDT) control unit to identify the optical information storage medium as:
a single-layer optical information storage medium if the first time period is greater than a first reference value and less than a second reference value; and
a multi-layer optical information storage medium if the first time period is greater than a third reference value, which is greater than the second reference value, and less than a fourth reference value.

16. The apparatus as claimed in claim 14, wherein if the first time period is less than the first reference value, a surface layer of the optical information storage medium is identified as corresponding to the sum signal having the value greater than the first level.

17. The apparatus as claimed in claim 13, further comprising:
a spherical aberration correction unit to output a signal to the optical pickup unit in order to correct a spherical aberration of the optical information storage medium according to the identified number of the data layers of the optical information storage medium.

18. The apparatus as claimed in claim 12, wherein the first direction is an upward direction towards the optical information storage medium and the second direction is a downward direction away from the optical information storage medium.

19. The apparatus as claimed in claim 12, wherein the optical pickup unit moves the object lens to a lowest position of the optical information storage medium to detect a surface layer of the optical information storage medium before the moving of the object lens in the first direction or the second direction.

20. The apparatus as claimed in claim 12, wherein the predetermined velocity is a constant velocity.

21. The apparatus as claimed in claim 14, wherein the DDT control unit controls the optical pickup unit to adjust a power value of a laser diode emitting the beams if the first time period is greater than the sixth reference value.

22. The apparatus as claimed in claim 14, wherein the DDT control unit checks a load state of the optical information storage medium if the first time period is greater than the sixth reference value.

23. A method of identifying a type of an optical information storage medium loaded into an apparatus for reproducing/recording the optical information storage medium and generating a radio frequency direct current (RFDC) signal corresponding to magnitudes of beams reflected by the optical information storage medium, the method comprising:
measuring a first time period during which the RFDC signal has a value greater than a first level; and
determining a number of data layers of the optical information storage medium based on the first time period, wherein the number of the data layers corresponds to the type of the optical information storage medium.

24. The method as claimed in claim 23, wherein the measuring of the first time period comprises:
measuring the first time period from a first time that the RFDC signal has a value greater than the first level until a last time that the RFDC signal has a value greater than the first level.

25. The method as claimed in claim 23, wherein the determining of the number of the data layers of the optical information storage medium comprises:
identifying the optical information storage medium as a single-layer optical information storage medium if the first time period is greater than a first reference value and less than a second reference value;
identifying the optical information storage medium as a dual-layer optical information storage medium if the first time period is greater than a third reference value, which is greater than the second reference value, and less than a fourth reference value; and
identifying the optical information storage medium as a multi-layer optical information storage medium if the first time period is greater than a fifth reference value, which is greater than the fourth reference value, and less than a sixth reference value.

26. The method as claimed in claim 23, wherein the determining of the number of the data layers of the optical information storage medium comprises:
identifying the optical information storage medium as a single-layer optical information storage medium if the first time period is greater than a first reference value and less than a second reference value; and
identifying the optical information storage medium as a multi-layer optical information storage medium if the first time period is greater than a third reference value, which is greater than the second reference value, and less than a fourth reference value.

27. The method as claimed in claim 25, wherein if the first time period is less than the first reference value, a surface layer of the optical information storage medium is identified as corresponding to the sum signal having the value greater than the first level.

28. An apparatus for identifying a type of an optical information storage medium loaded into a device for reproducing/recording the optical information storage medium and generating a radio frequency direct current (RFDC) signal corresponding to magnitudes of beams reflected by the optical information storage medium, the apparatus comprising:
a detect disc type (DDT) control unit to measure a first time period during which the RFDC signal has a value greater than a first level and to detect a number of data layers of the optical information storage medium based on the first time period, wherein the number of the data layers corresponds to the type of the optical information storage medium.

29. The apparatus as claimed in claim 28, wherein the DDT control unit measures the first time period from a first time that the RFDC signal has a value greater than the first level until a last time that the RFDC signal has a value greater than the first level.

30. The apparatus as claimed in claim 28, wherein the DDT control unit identifies the optical information storage medium as:
a single-layer optical information storage medium if the first time period is greater than a first reference value and less than a second reference value;
a dual-layer optical information storage medium if the first time period is greater than a third reference value, which is greater than the second reference value, and less than a fourth reference value; and
a multi-layer optical information storage medium if the first time period is greater than a fifth reference value, which is greater than the fourth reference value, and less than a sixth reference value.

31. The apparatus as claimed in claim 28, wherein the DDT control unit identifies the optical information storage medium as:
a single-layer optical information storage medium if the first time period is greater than a first reference value and less than a second reference value; and
a multi-layer optical information storage medium if the first time period is greater than a third reference value, which is greater than the second reference value, and less than a fourth reference value.
